(19) United States
(12) Patent Application Publication
(10) Pub. No.: US 2019/0000243 A1
(43) Pub. Date: Jan. 3, 2019

(54) DISPLAY STAND

(71) Applicant: KapStone Container Corporation, Northbrook, IL (US)

(72) Inventor: Joe ERTL, Richfield, MN (US)

(21) Appl. No.: 16/106,142

(22) Filed: Aug. 21, 2018

Related U.S. Application Data
(63) Continuation-in-part of application No. 15/942,603, filed on Apr. 2, 2018.
(60) Provisional application No. 62/483,557, filed on Apr. 10, 2017.

(51) Int. Cl. A47F 5/11; G09F 1/06

(52) U.S. Cl. CPC A47F 5/112; G09F 1/06

(57) ABSTRACT

A display stand in accordance with the present disclosure includes a display header and a frame. The display header is coupled to the frame for showing product indicia related to products to a customer at a retail location.

### PRIORITY CLAIM

This application is a continuation-in-part of U.S. patent application Ser. No. 15/942,603 filed Apr. 2, 2018, which claims priority under 35 U.S.C. § 119(e) to U.S. Provisional Application Ser. No. 62/483,557, filed Apr. 10, 2017, each of which is expressly incorporated by reference herein.

### BACKGROUND

The present disclosure relates to a display stand, and particularly to a display stand having a display header and a frame. More particularly, the present disclosure relates to a display stand having a display header attached to a frame for showing product indicia related to products to a customer at a retail location.

### SUMMARY

A display stand in accordance with the present disclosure includes a display header and a frame. The display header is coupled to the frame for showing product indicia related to products to a customer at a retail location.

In illustrative embodiments, the display header is positioned between opposing sides of the frame. The display header includes a header board and a header mount. The header mount engages with the frame and the header board to support the header board relative to the frame.

In illustrative embodiments, the header board is movable from a shipping position to a display position relative to the frame. The product indicia is obscured by the frame when the header board is in the shipping position and visible when the header board is in the display position.

In illustrative embodiments, the header mount includes a pair of elastic members. The elastic members are configured to move the header board from the shipping position to the display position at the selection of a user. The elastic members are coupled to the frame and a lower end of the header board to support the header board relative to the frame for movement between the shipping and display positions.

In illustrative embodiments, the frame is formed to define a pocket configured to receive the header board. The pocket locates the header board relative to exterior sides of the frame. The header board rides in the pocket between the shipping and display positions.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a front perspective view of a display stand in accordance with the present disclosure showing that the display stand includes a display header coupled to a frame for showing product indicia related to products to a customer at a retail location when the display header is in a display position;

FIG. 2 is a view similar to FIG. 1 showing the display header in a shipping position and suggesting that a header board of the display header slides in a pocket of the frame to obscure at least a portion of the product indicia when the header board is moved to the shipping position;

FIG. 3 is a rear perspective view of the display stand of FIG. 1 showing that the display header includes the header board and a header mount coupled to the header board and the frame to bias the header board toward the display position and suggesting that a header lock is formed between the header board and the frame to hold the header board in the shipping position at the selection of a user;

FIG. 4 is a view similar to FIG. 3 showing the header board in the display position and suggesting that release of the header lock at the selection of a user allows the header mount to move the header board to the display position;

FIGS. 5-22 are a series of views showing a process in accordance with the present disclosure for assembling the display stand;

FIGS. 23-27 are a series of views showing a process in accordance with the present disclosure for erecting the display stand;

FIG. 28 is a top plan view of an embodiment of a frame blank in accordance with the present disclosure used to form the frame of FIG. 3 showing that the frame blank includes a front panel, back panels, and a brace flap and suggesting that the panels and brace flap fold relative to one another to form the frame; and

FIG. 29 is a top plan view of an embodiment of a header-board blank in accordance with the present disclosure used to form the header board of FIG. 3.

### DETAILED DESCRIPTION

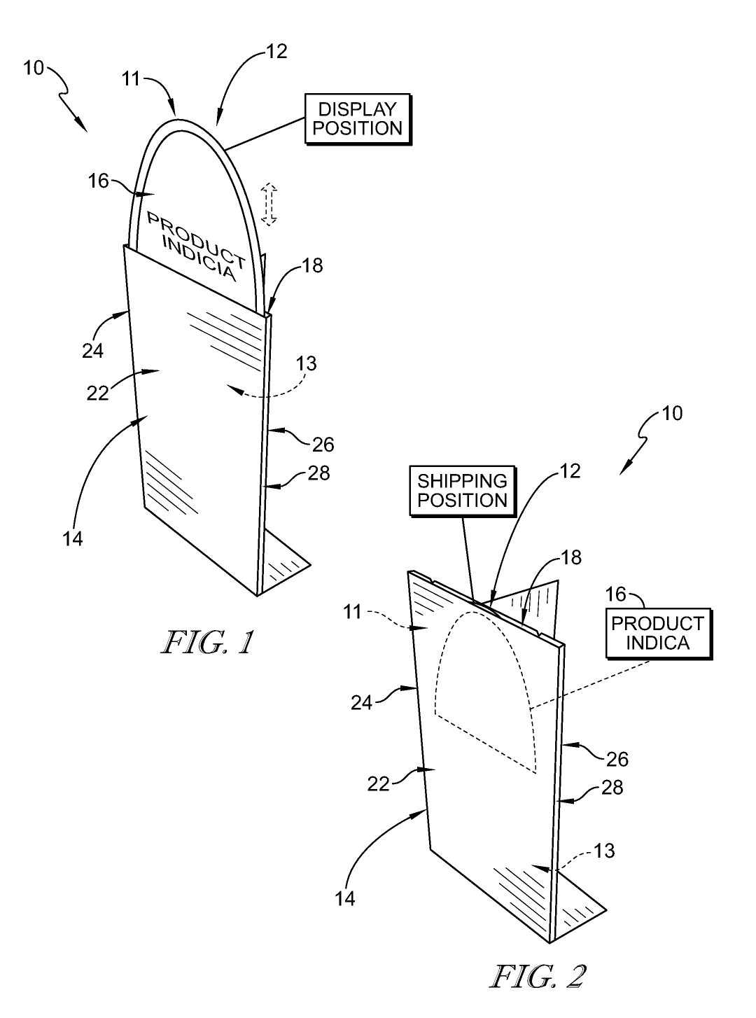

A display stand 10 in accordance with the present disclosure is shown in FIG. 1. Display stand 10 includes a display header 12 coupled to a frame 14. Frame 14 is configured to support display header in a retail setting. Product indicia 16 related to available products at the retail location is positioned on a front side of display header 12 and visible when display header 12 is in a display position as shown in FIG. 1.

Display header 12 includes a header board 11 and a header mount 13 coupled to frame 14 to support header board 11 for movement relative to frame 14 between the display position, as shown in FIG. 1, and a shipping position, as shown in FIG. 2, at the selection of a user. At least a portion of product indicia 16 is obscured from view when header board 11 is in the shipping position and a height of display stand 10 is reduced compared to when header board 11 is in the display position. In the illustrative embodiment, header mount 13 biases header board 11 toward the display position to support the header board 11 in the display position for showing product indicia 16 to customers at a retail location as suggested in FIG. 1.

Header board 11 is received in a pocket 18 of frame 14 as suggested in FIGS. 1 and 2. Pocket 18 extends into frame 14 and is positioned to lie within exterior sides 22, 24, 26, 28 of frame 14. Pocket 18 locates header board 11 relative to frame 14 and is configured to guide header board 11 between the display and shipping positions. Pocket 18 and header board 11 are aligned with a front side 22 and a back side 26 of frame 14, but other orientations for pocket 18 and header board 11 are contemplated by the present disclosure.

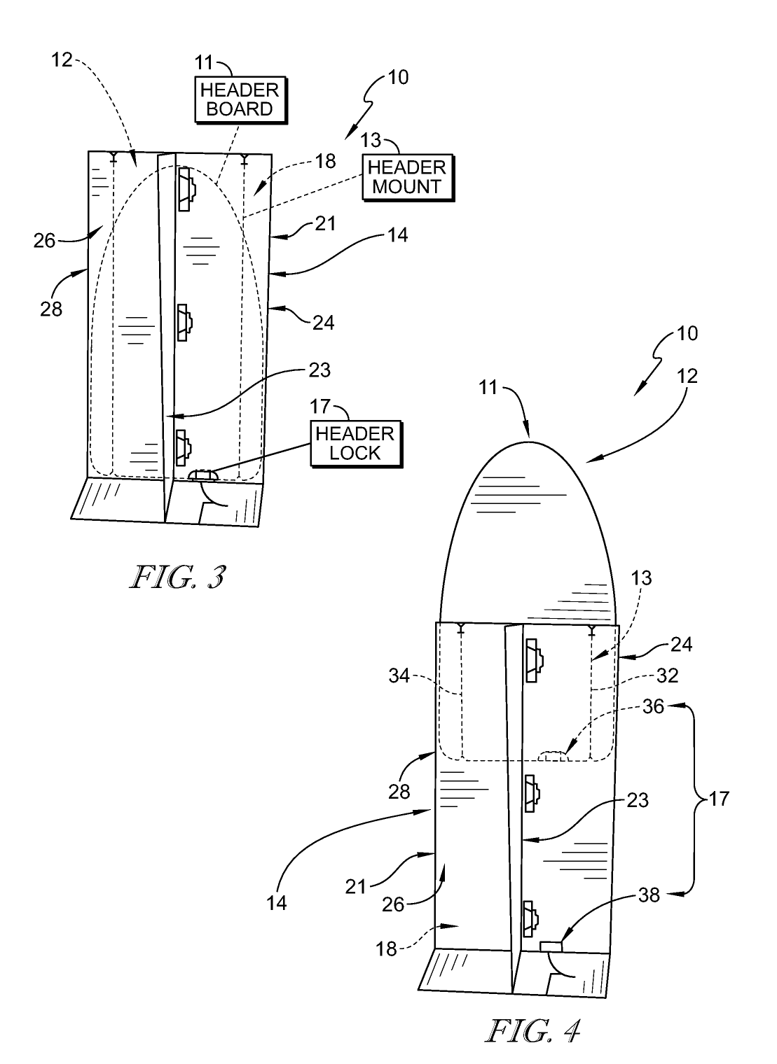

In the illustrative embodiment, frame 14 includes a body 21 and a prop 23 coupled to body 21 for supporting frame 14 in an upright position as shown in FIG. 3. Prop 23 extends rearward and along body 21 to provide a foundation for supporting display stand 10 on a surface. Header mount 13 includes elastic members 32, 34 that engage with frame 14 and header board 11 to support header board 11 on frame 14. In some embodiments, elastic members 32, 34 are formed as elongated strands of stretchable material, and the number of elastic members 32, 34 can be increased or decreased to adjust for size, weight, display position height, etc. of display header 12.

A header lock 17 is formed between header board 11 and frame 14 to hold header board 11 in the shipping position against the bias of header mount 13 at the selection of a user as shown in FIG. 3. Header lock 17 includes a lock tab 36 of header board 11 that engages with a lock slot 38 of frame 14 as suggested in FIG. 4. Lock tab 36 is released from lock slot 38 to allow header mount to move header board 11 to the display position.

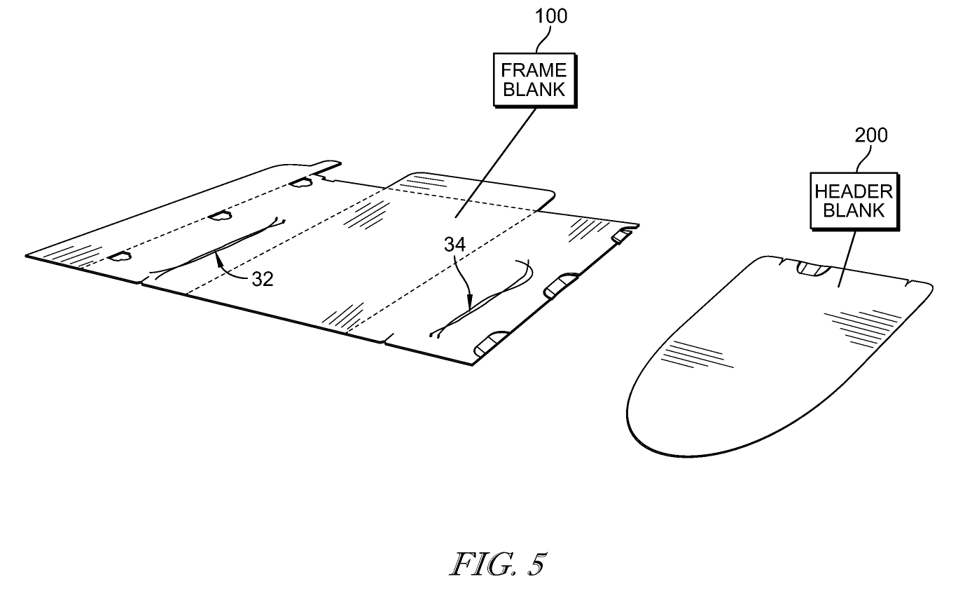

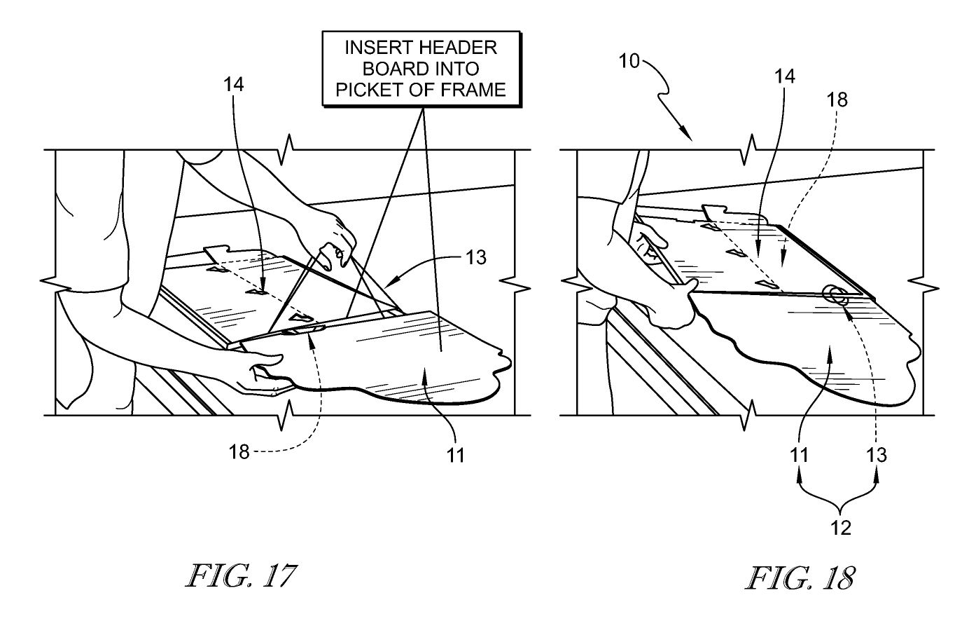

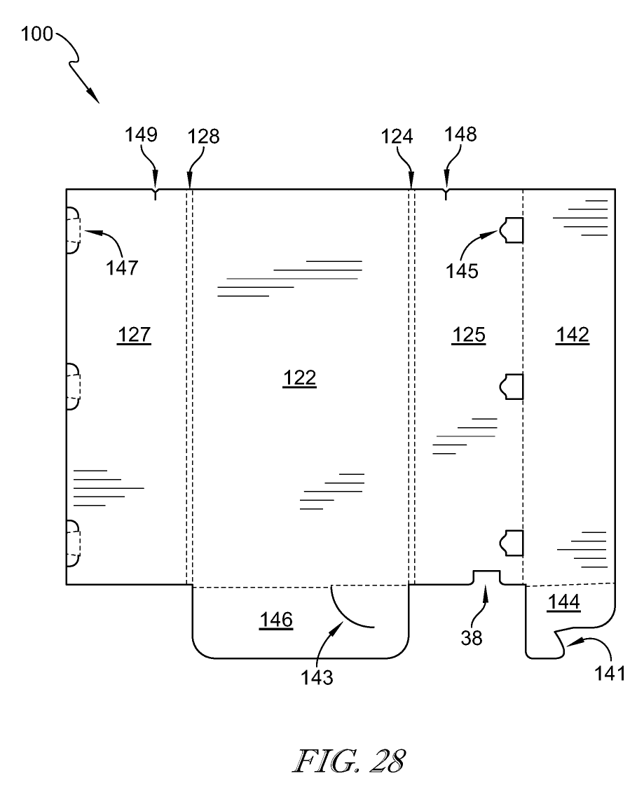

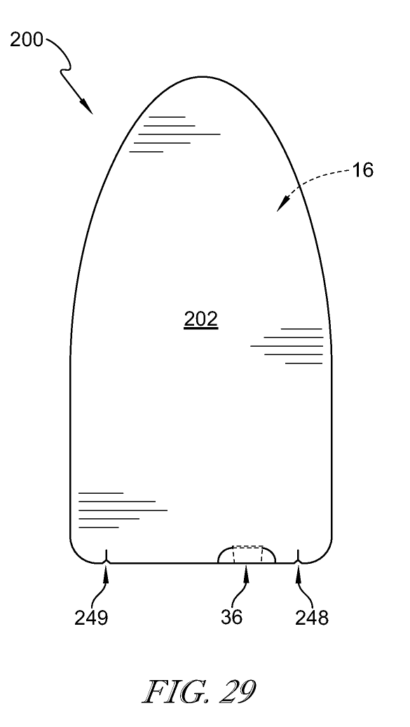

One illustrative process for assembling display stand 10 is shown in FIGS. 5-22. A frame blank 100, header blank 200, and elastic members 32, 34 are collected as suggested in FIG. 5. Frame blank 100 is shown in FIG. 28 and used to form frame 14. Header blank 200 is shown in FIG. 29 and defines header board 11. Header blank 200 and header board 11 may be used interchangeably herein.

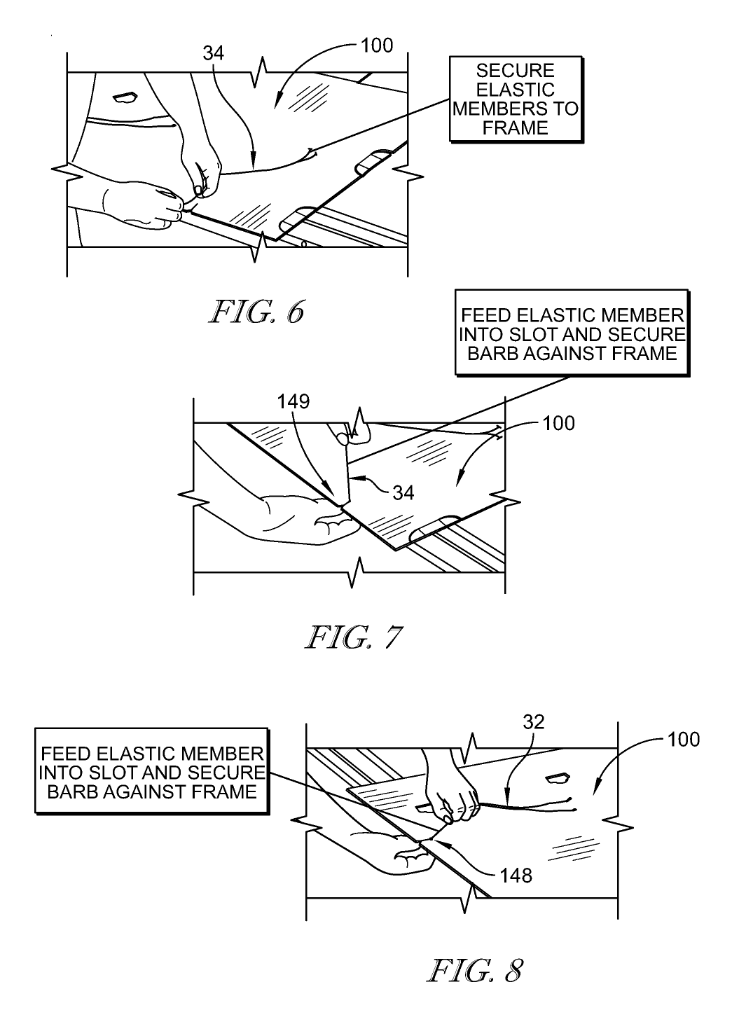

Elastic members 32, 34 are secured to frame blank 100 as suggested in FIGS. 6-8. Each elastic member 32, 34 includes barbs positioned at opposing ends thereof. Elastic member 34 is fed into a slot 149 of frame blank 100 and one of the barbs is secured against frame blank 100 as suggested in FIG. 7. Elastic member 32 is fed into a slot 148 of frame blank 100 and one of the barbs is secured against frame blank 100 as suggested in FIG. 8.

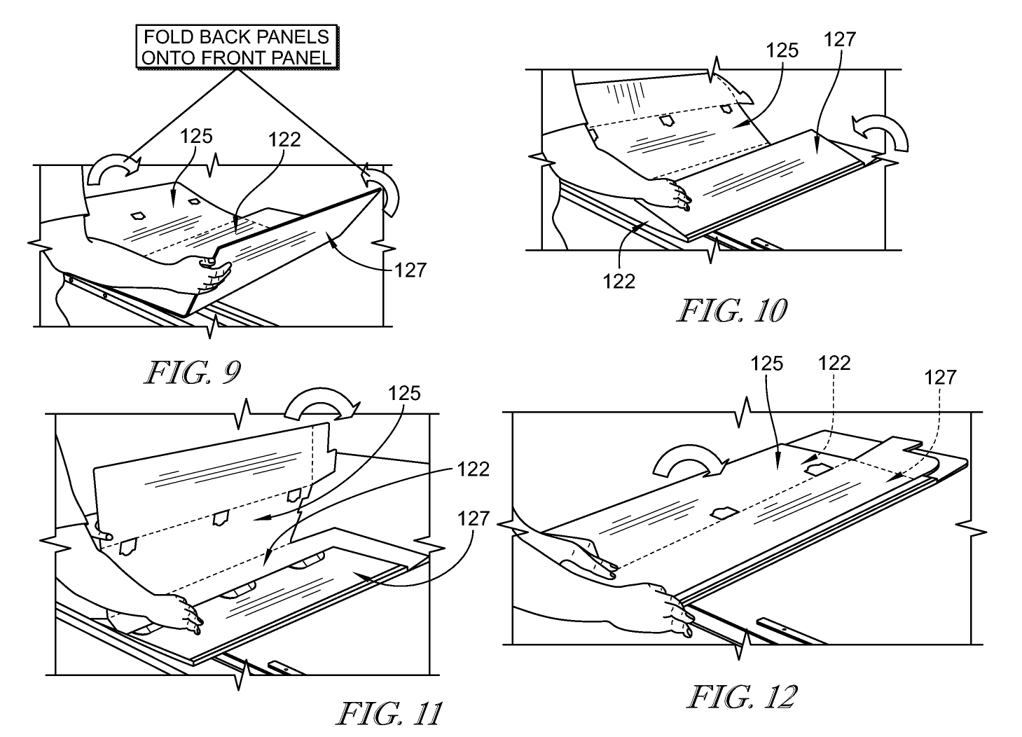

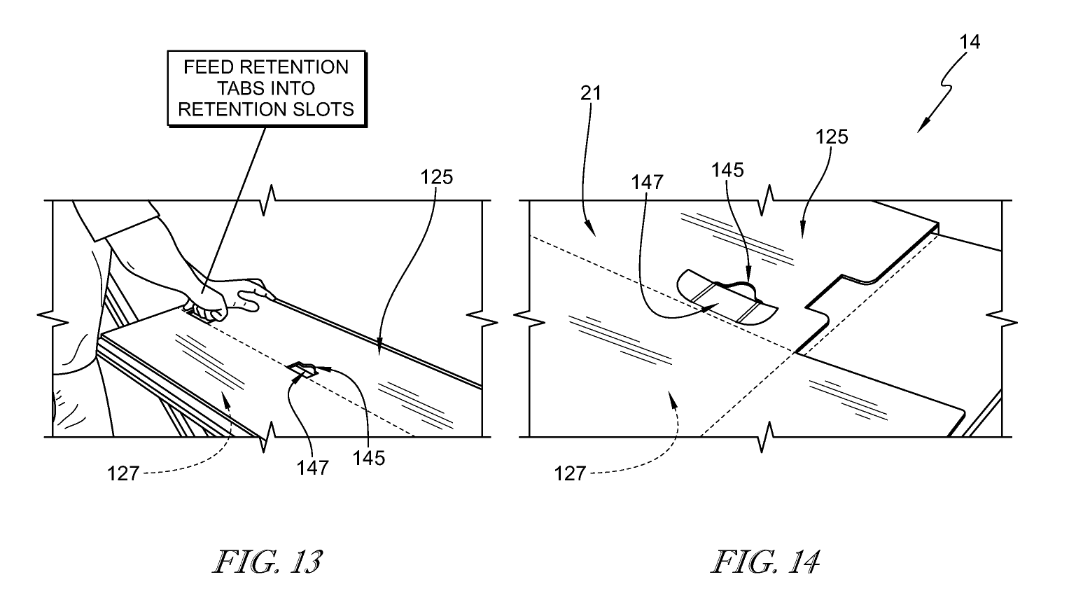

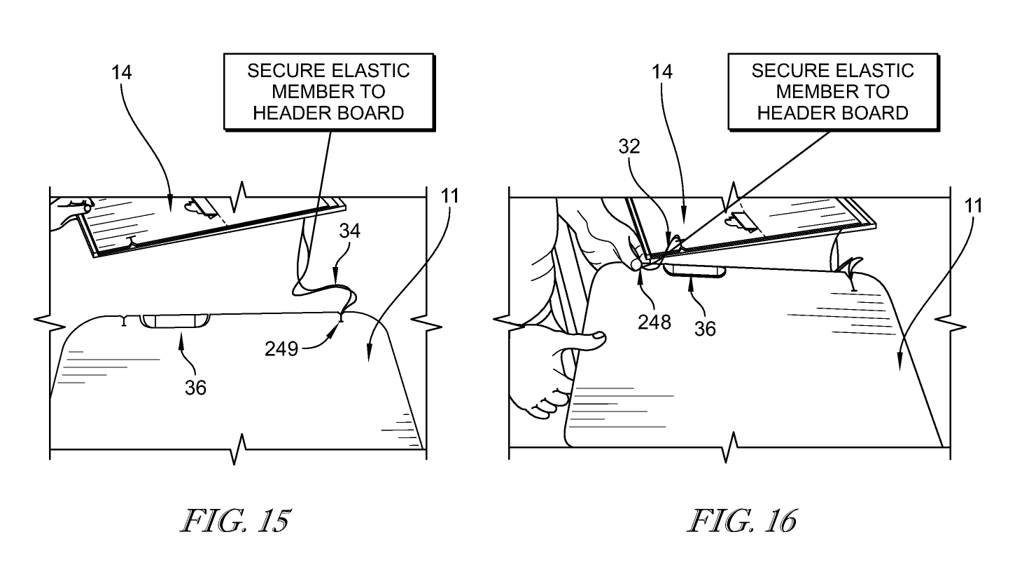

Back panels 125, 127 are folded relative to a front panel 122 of frame blank 100 as suggested in FIGS. 9-12. Retention tabs 147 of back panel 127 are fed into retention slots 145 of back panel 125 to hold back panels 125, 127 relative to one another and form body 21 of frame 14 as suggested in FIGS. 13 and 14. Elastic members 32, 34 are fed into slots 248, 249, respectively, of header board 11, and header board 11 is inserted into pocket 18 of frame 14 to form display stand 10 as suggested in FIGS. 15-18.

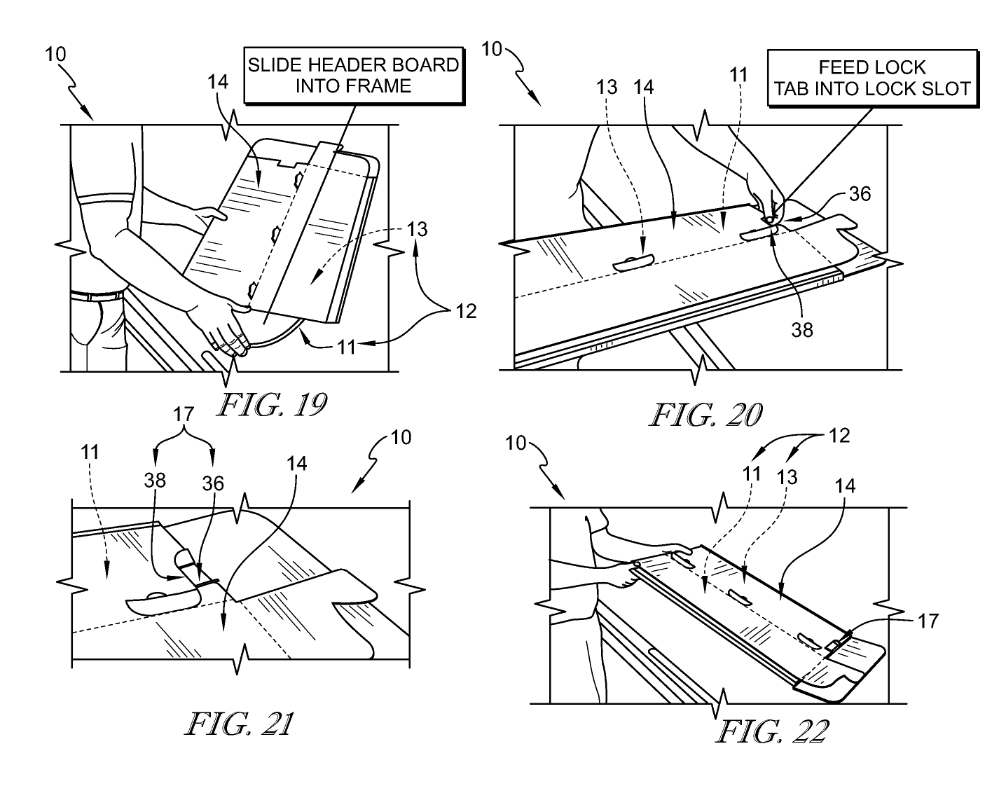

Elastic members 32, 34 of header mount 13 are configured to stretch to allow header board 11 to slide in pocket 18 between the display and shipping positions at the selection of a user. Header board 11 is moved to the shipping position and lock tab 36 is fed into lock slot 38 to hold header board 11 in the shipping position as suggested in FIGS. 19-22. The assembled display stand 10 can be shipped to a retail location in a flat configuration (as shown in FIG. 22) to minimize a profile of display stand 10.

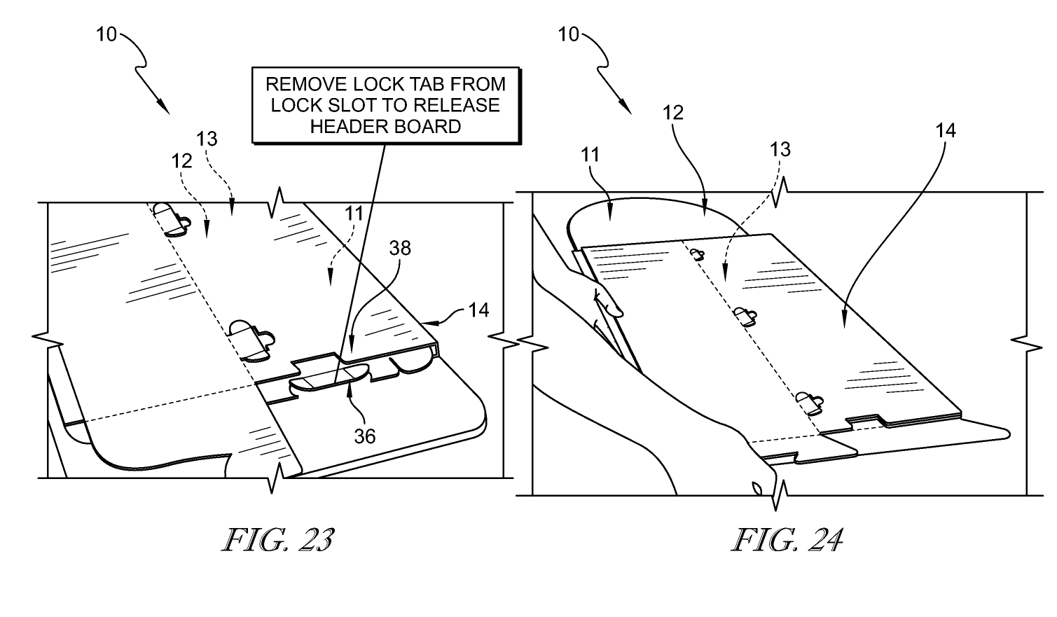

One illustrative process for erecting display stand 10 in a retail location is shown in FIGS. 23-27. A user of display stand 10 releases header lock 17 by removing lock tab 36 from lock slot 38 as shown in FIG. 23. Header mount 13 moves header board 11 to the display position for showing product indicia 16 to customers at the retail location as suggested in FIG. 24.

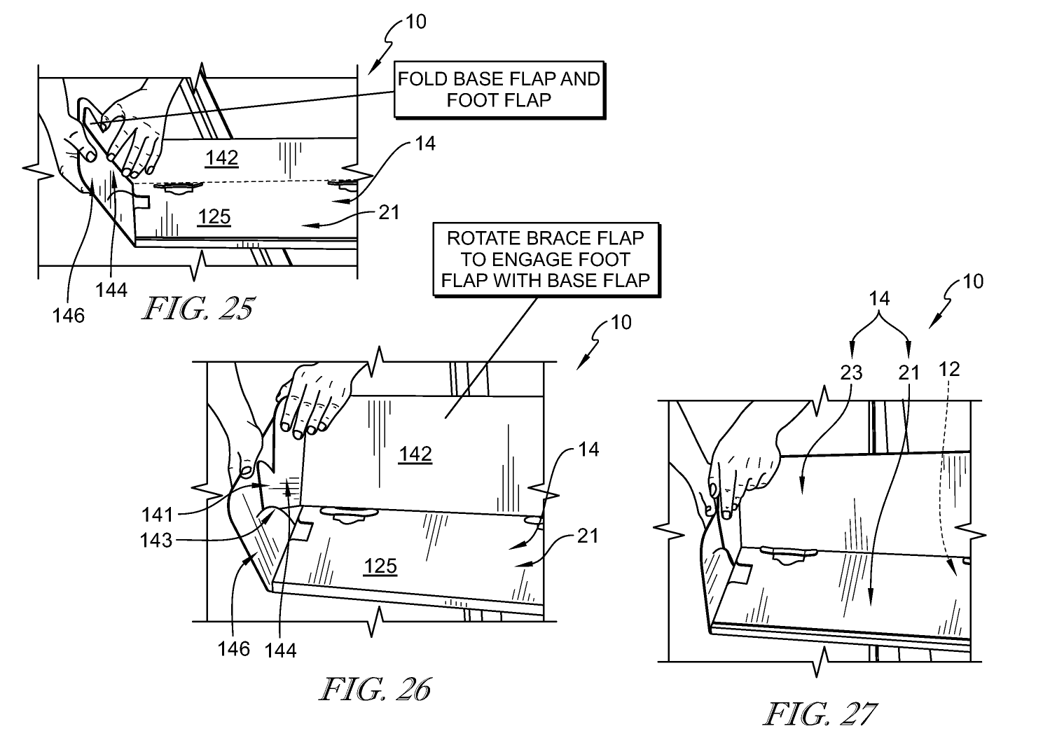

Prop 23 is movable between a collapsed-storage position, during storage and shipping of display stand 10 for example, to an expanded-use position, for supporting display stand 10 in an upright orientation, as suggested in FIGS. 25-27. Prop 23 is shown in the collapsed-storage position in FIG. 25. In the illustrated embodiment, prop 23 includes a brace flap 142, a foot flap 144, and a base flap 146. Brace flap 142, foot flap 144, and base flap 146 are substantially parallel with body 21 in the collapsed-storage position. Prop 23 extends rearward and along body 21 in the expanded-use position as suggested in FIG. 3.

One illustrative embodiment for erecting prop 23 from the collapsed-storage position is illustrate din FIGS. 25-27. Foot flap 144 and base flap 146 fold relative to body 21 of frame 14 as shown in FIG. 25. Brace flap 142 folds relative to body 21 to move foot flap 144 relative to base flap 146. A hook tab 141 of foot flap 144 is inserted into a slot 143 of base flap 146 to hold brace flap 142 relative to base flap 146 and form prop 23 as suggested in FIGS. 26 and 27. In the illustrative embodiment, brace flap 142 is substantially perpendicular to body 21 and base flap 146 in the expanded-use position, but other angles are contemplated by the present disclosure.

Blanks 100, 200 used to form display stand 10 are shown in FIGS. 28 and 29. Blanks 100, 200 are made, for example, of corrugated material. As shown and described herein, when making reference to a blank of material, solid lines denote a cut line where adjacent portions of material are severed from one another and dashed lines denote a fold line where portions of material are folded relative to one another. In some examples, fold lines are scored or perforated. Frame 14 is formed by erecting frame blank 100 as described above, and header blank 200 defines header board 11.

Frame blank 100 includes panels 122, 125, 127 coupled by spacer strips 124, 128 and flaps 142, 144, 146 as shown in FIG. 28. A back panel 127 is coupled to a front panel 122 by a spacer strip 128. A back panel 125 is coupled to front panel 122 by a spacer strip 124. Front panel 122 and spacer strips define sides 22, 24, 28, respectively, of frame 14. Back panels 125, 127 together form side 26 of frame 14.

A brace flap 142 is coupled to back panel 125 as shown in FIG. 28. A foot flap 144 is coupled to brace flap 142. A base flap 146 is coupled to front panel 122. Back panel 125 is formed to include lock slot 38 and retention slots 145. Retention tabs 147 are coupled to back panel 127. A hook tab 141 extends from foot flap 144. Base flap 146 is formed to include a slot 143.

Header blank 200 includes a body 202 and lock tab 36 coupled to body 202 as shown in FIG. 29. Product indicia 16 is position on body 202. Slots 248, 249 are formed into body 202.

In illustrative embodiments, display stands can be of various sizes, such as ¼ pallet, half pallet, and full pallet for example. The display headers automatically pop-up when used. The display headers are adaptable for use with a variety of frames in a retail environment.

In illustrative embodiments, the display headers include elastic bands and a graphic header board which in combination attach to a frame. Once the display header is attached to a frame, the graphic header board is moved into the down position for shipment. A header lock holds the header board in the shipping position during shipment. Once the display stand arrives to its intended destination (e.g., a retail location), a user releases the header lock and the header board will automatically be lifted upward via the elastic bands into the up position for showing the graphics on the front and/or back. The user then folds together the prop to erect the display stand.

In illustrative embodiments, no labor is involved by a user in the retail setting for installing the header board onto the frame. This solves a problem in that current graphic headers ship loose or separate. Many times those loose headers are placed on the top or may be attached via plastic rivets or clips. In either case, a user must find the header (if loose), read the set up instruction sheet, and attach the header. The display headers of the present disclosure automatically move the graphic element (e.g., header board) up into position meeting retail compliance requirements and saving labor.

1. A display stand comprising:
a frame defining a pocket, and
a display header coupled to the frame, the display header including a header board and a header mount coupled to the frame in a fixed position relative to the frame,
wherein the header board is at least partially received in the pocket of the frame, and the header mount is configured to provide means for supporting the header board in a display position where product indicia positioned on the header board is visible and to allow the header board to move in the pocket relative to the frame to a shipping position at the selection of a user where at least a portion of the product indicia is obscured by the frame and to reduce a height of the display stand.

2. The display stand of claim 1, wherein the header mount includes at least one elastic member configured to bias the header board toward the display position.

3. The display stand of claim 2, wherein the at least one elastic member is coupled to the frame and the header board.

4. The display stand of claim 1, wherein the frame includes a body defining the pocket and a prop coupled to the body to support the display stand in an upright position.

5. The display stand of claim 4, wherein the prop includes a base flap extending rearward of the body and a brace flap extending rearward of the body, and wherein the brace flap is substantially perpendicular to the body and to the base flap.

6. The display stand of claim 1, further comprising a header lock formed between the header board and the frame and configured to hold the header board in the shipping position at the selection of a user.

7. The display stand of claim 6, wherein the header lock includes a lock tab coupled to the header board and a lock slot formed in the frame, wherein the lock tab is configured to engage with the lock slot at the selection of a user.

8. A display stand comprising:
a frame defining a pocket, the frame erected from a frame blank, the frame blank comprising:
a front panel,
a first back panel coupled to the front panel by a first spacer strip,
a second back panel coupled to an opposing side of the front panel from the first back panel by a second spacer strip,
a brace flap coupled to the second back panel, and
a base flap coupled to the front panel, and
a display header coupled to the frame, the display header including a header board and a header mount coupled to the frame in a fixed position relative to the frame,
wherein the header board is at least partially received in the pocket of the frame, and the header mount is configured to provide means for supporting the header board in a display position where product indicia positioned on the header board is visible and to allow the header board to move in the pocket relative to the frame to a shipping position at the selection of a user where at least a portion of the product indicia is obscured by the frame and to reduce a height of the display stand.

9. The display stand of claim 8, wherein the header mount includes at least one elastic member configured to bias the header board toward the display position.

10. The display stand of claim 9, wherein the at least one elastic member is coupled to the frame and the header board.

11. The display stand of claim 8, wherein the frame includes a body defining the pocket and a prop coupled to the body to support the display stand in an upright position.

12. The display stand of claim 11, wherein the base flap engages with the brace flap to form the prop, wherein the base flap extends rearward of the body and the brace flap extends rearward of the body, and wherein the brace flap is substantially perpendicular to the body and to the base flap.

13. The display stand of claim 8, further comprising a header lock formed between the header board and the frame and configured to hold the header board in the shipping position at the selection of a user.

14. The display stand of claim 13, wherein the header lock includes a lock tab coupled to the header board and a lock slot formed in the frame, wherein the lock tab is configured to engage with the lock slot at the selection of a user.

15. A display stand comprising:
a frame including a body defining a pocket and a prop coupled to the body, the prop movable between a collapsed-storage position substantially parallel to the body and an expanded-use position extending rearward and along the body, and
a display header coupled to the frame, the display header including a header board and a header mount coupled to the frame in a fixed position relative to the frame,
wherein the header board is at least partially received in the pocket of the frame, and the header mount is configured to provide means for supporting the header board in a display position where product indicia positioned on the header board is visible and to allow the header board to move in the pocket relative to the frame to a shipping position at the selection of a user where at least a portion of the product indicia is obscured by the frame and to reduce a height of the display stand.

16. The display stand of claim 15, wherein the header mount includes at least one elastic member configured to bias the header board toward the display position.

17. The display stand of claim 16, wherein the at least one elastic member is coupled to the frame and the header board.

18. The display stand of claim 15, wherein the prop includes a base flap coupled to the body for movement relative to the body and a brace flap coupled to the body for movement relative to the body, wherein the base flap extends rearward of the body and the brace flap extends rearward of the body to engage with the base flap in the expanded-use position of the prop, and wherein the brace flap is substantially perpendicular to the body and to the base flap in the expanded-use position.

19. The display stand of claim 15, further comprising a header lock formed between the header board and the frame and configured to hold the header board in the shipping position at the selection of a user.

20. The display stand of claim 19, wherein the header lock includes a lock tab coupled to the header board and a lock slot formed in the frame, wherein the lock tab is configured to engage with the lock slot at the selection of a user.
